(19) United States
(12) Patent Application Publication
(10) Pub. No.: US 2011/0095650 A1
(43) Pub. Date: Apr. 28, 2011

(54) ULTRASONIC MOTOR

(75) Inventor: Hiromichi SAKANO, Fuchu-shi (JP)

(73) Assignee: OLYMPUS CORPORATION, Tokyo (JP)

(21) Appl. No.: 12/912,036

(22) Filed: Oct. 26, 2010

(30) Foreign Application Priority Data
Oct. 28, 2009 (JP) 2009-248047

(51) Int. Cl. H02N 2/12

(52) U.S. Cl. 310/323.16

(57) ABSTRACT

An ultrasonic motor is configured as follows. Namely, the ultrasonic motor includes a vibrator, a rotor, a press mechanism, a frame, and a regulating unit. The vibrator's section perpendicular to a central axis has a rectangular shape, in which a ratio of a short side to a long side that form the rectangular shape is set to a predetermined value. And the vibrator generates an elliptic vibration by simultaneously exciting a longitudinal vibration stretching along the central axis, and a torsional vibration. The rotor mechanism abuts against an elliptic vibration generating surface of the vibrator and is driven by the elliptic vibration to rotate using the central axis as an axis of rotation. The press mechanism presses the vibrator against the rotor mechanism. The frame supports the rotor mechanism and the vibrator. The regulating unit regulates rotation of the vibrator by clamping the vibrator together with the frame.

### CROSS-REFERENCE TO RELATED APPLICATIONS

This application is based upon and claims the benefit of priority from prior Japanese Patent Application No. 2009-248047, filed Oct. 28, 2009, the entire contents of which are incorporated herein by reference.

### BACKGROUND OF THE INVENTION

1. Field of the Invention

The present invention relates to an ultrasonic motor using vibrations of a vibrator such as a piezoelectric element.

2. Description of the Related Art

Recently, an ultrasonic motor using vibrations of a vibrator such as a piezoelectric element is receiving attention as a novel motor which replaces an electromagnetic motor. The ultrasonic motor is superior to the conventional electromagnetic motor because it can obtain high thrust at low speed without any gear, has high holding force, long stroke, and high resolving power, is very quiet, and does not generate magnetic noise.

In the ultrasonic motor, an ultrasonic vibrator is pressed against a driven member serving as a relative motion member via a driving member serving as a frictional member, thereby generating a frictional force between the driving member and the driven member. The driven member is driven by the frictional force.

For example, the following ultrasonic motor is known. In this ultrasonic motor, longitudinal and torsional vibrations are simultaneously generated in the ultrasonic vibrator, generating elliptic vibrations as a composition of the vibrations in the ultrasonic vibrator. By using the elliptic vibrations, the driven member is driven. As a technique concerning the ultrasonic motor, for example, Jpn. Pat. Appln. KOKAI Publication No. 9-121573 discloses the following technique.

According to the technique disclosed in Jpn. Pat. Appln. KOKAI Publication No. 9-121573, longitudinal and torsional vibrations are simultaneously excited in a rod-like elastic member using stretching/contracting vibrations of two laminated piezoelectric elements arranged to face each other on the side surfaces of the rod-like elastic member. An elliptic motion is excited in a driving member arranged on the end face of the rod-like elastic member, rotating a rotor by the driving member.

More specifically, in the ultrasonic motor disclosed in Jpn. Pat. Appln. KOKAI Publication No. 9-121573, a groove is formed in the rod-like elastic member to make the frequencies of longitudinal and torsional vibrations almost coincide with each other. By adjusting the groove position, the resonant frequencies of the frequencies of longitudinal and torsional vibrations almost coincide with each other.

A through hole is formed in the direction of length at the center of the rod-like elastic member. A shaft is inserted into the through hole and fixed. The driving member which has received the driving force from the elliptic vibrations rotates the rotor supported using the shaft as a reference.

However, the ultrasonic motor disclosed in Jpn. Pat. Appln. KOKAI Publication No. 9-121573 cannot be easily assembled because of the following reasons.

More specifically, in the ultrasonic motor disclosed in Jpn. Pat. Appln. KOKAI Publication No. 9-121573, the laminated piezoelectric element and rod-like elastic member need to be bonded and fixed. Further, the rod-like elastic member needs to be processed to form a groove in order to make the frequencies of longitudinal and torsional vibrations almost coincide with each other. These requirements impair the ease of assembly.

### BRIEF SUMMARY OF THE INVENTION

The present invention has been made in consideration of the above situation, and has as its object to provide an ultrasonic motor which can be assembled easily.

In order to achieve the above object, according to a first aspect of the invention, there is provided an ultrasonic motor comprising:

a vibrator whose section perpendicular to a central axis has a rectangular shape, in which a ratio of a short side to a long side that form the rectangular shape is set to a predetermined value, and which generates an elliptic vibration by simultaneously exciting a longitudinal vibration stretching along the central axis, and a torsional vibration using the central axis as an axis of torsion;

a rotor mechanism which abuts against an elliptic vibration generating surface of the vibrator and is driven by the elliptic vibration to rotate using the central axis as an axis of rotation;

a press mechanism which presses the vibrator against the rotor mechanism to bring the elliptic vibration generating surface of the vibrator into press contact with the rotor mechanism;

a frame which supports the rotor mechanism and the vibrator; and

a regulating unit which regulates rotation of the vibrator by clamping the vibrator together with the frame.

The present invention can provide an ultrasonic motor which can be assembled easily.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view exemplifying the structure of an ultrasonic motor according to the first embodiment of the present invention;

FIG. 2A is an exploded perspective view exemplifying the structure of a rotor mechanism;

FIG. 2B is a view showing a state in which a laminated piezoelectric element is inserted into a housing;

FIG. 3 is a view showing a rotation regulating member in detail;

FIG. 4 is a sectional view taken along a line A-A′ shown in FIG. 1;

FIG. 5A is an exploded perspective view exemplifying the structure of a piezoelectric sheet laminated body;

FIG. 5B is a perspective view showing a position where the laminated piezoelectric element is cut out from the piezoelectric sheet laminated body;

FIG. 5C is a perspective view showing the structure of the laminated piezoelectric element cut out from the piezoelectric sheet laminated body;

FIG. 6A is a perspective view exemplifying the vibration state of the laminated piezoelectric element;

FIG. 6B is a perspective view exemplifying the vibration state of the laminated piezoelectric element;

FIG. 6C is a perspective view exemplifying the vibration state of the laminated piezoelectric element;

FIG. 6D is a perspective view exemplifying the vibration state of the laminated piezoelectric element;

FIG. 6E is a perspective view exemplifying the vibration state of the laminated piezoelectric element;

FIG. 7 is a graph showing characteristics obtained when the height c of the laminated piezoelectric element is set constant, (short side length a/long side length b) values are plotted along the abscissa, and resonant frequency values in respective vibration modes are plotted along the ordinate;

FIG. 8A is an exploded perspective view exemplifying the structure of an ultrasonic motor according to the second embodiment of the present invention;

FIG. 8B is a perspective view exemplifying the structure of a rotation regulating mechanism;

FIG. 9A is an exploded perspective view exemplifying the structure of an ultrasonic motor according to the third embodiment of the present invention;

FIG. 9B is a perspective view exemplifying the structure of a rotation regulating mechanism; and

FIG. 9C is a side view exemplifying the structure of the rotation regulating mechanism.

### DETAILED DESCRIPTION OF THE INVENTION

An ultrasonic motor according to preferred embodiments of the present invention will now be described with reference to the accompanying drawing.

### First Embodiment

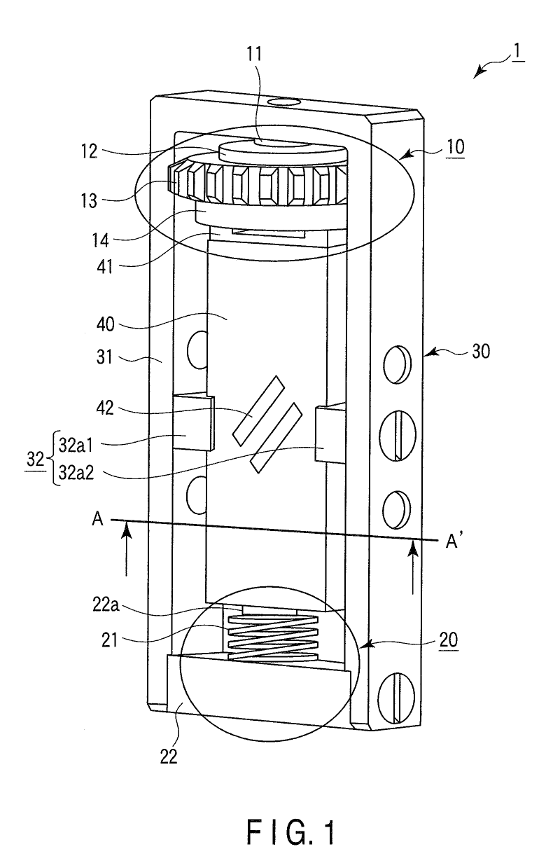

FIG. 1 is a view exemplifying the structure of an ultrasonic motor according to the first embodiment of the present invention. As shown in FIG. 1, an ultrasonic motor 1 according to the first embodiment comprises a rotor mechanism 10, press mechanism 20, housing 30, and laminated piezoelectric element 40.

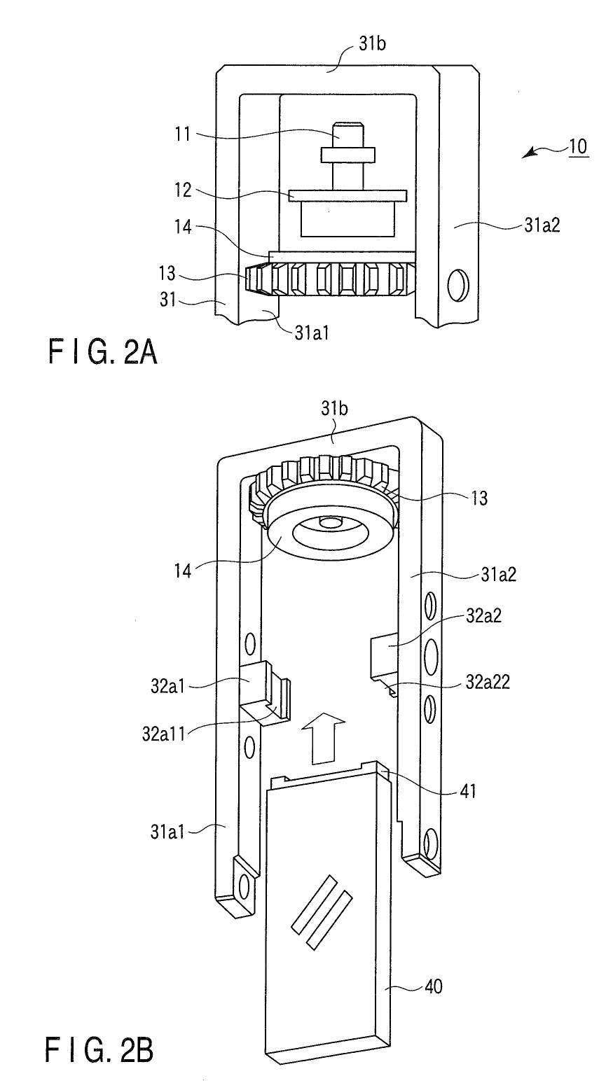

The rotor mechanism 10 includes a center shaft 11, bearing 12, gear 13, and sliding plate 14. FIG. 2A is an exploded perspective view exemplifying the structure of the rotor mechanism 10.

The center shaft 11 is a shaft member fixed to a frame 31 of the housing 30 (to be described later). Note that the building members of the rotor mechanism 10 are arranged concentrically with the center shaft 11.

The bearing 12 is a bearing member fitted on the center shaft 11.

The gear 13 is coupled to the bearing 12, and freely rotatably attached to the center shaft 11 via the bearing 12.

The sliding plate 14 is arranged in contact with a driving member 41 (to be described later), and transmits a driving force generated by the driving member to the gear 13.

The press mechanism 20 includes a spring 21, and a stationary plate 22 having a spring regulating member 22a.

The spring 21 is a spring member for pressing the laminated piezoelectric element 40 (to be described later) against the rotor mechanism 10. Examples of the spring 21 are a leaf spring and coil spring.

The stationary plate 22 is fixed to the frame 31 of the housing 30 (to be described later), and has the spring regulating member 22a which is a projection for positioning the spring 21. The spring regulating member 22a is inserted into the spring 21.

The housing 30 has the frame 31 and a rotation regulating member 32.

The frame 31 is a frame member whose section has an almost “U” shape, and holds the laminated piezoelectric element 40 together with the press mechanism 20 and rotation regulating member 32. More specifically, as shown in FIG. 2A, the frame 31 is formed from frame legs 31a1 and 31a2 which face each other, and a frame top 31b where the rotor mechanism 10 is arranged.

FIG. 2B is a view showing a state in which the laminated piezoelectric element 40 is inserted into the housing 30.

As shown in FIG. 2B, the rotation regulating member 32 includes a rotation regulating member 32a1 attached to the frame leg 31a1, and a rotation regulating member 32a2 attached to the frame leg 31a2. The rotation regulating members 32a1 and 32a2 face each other.

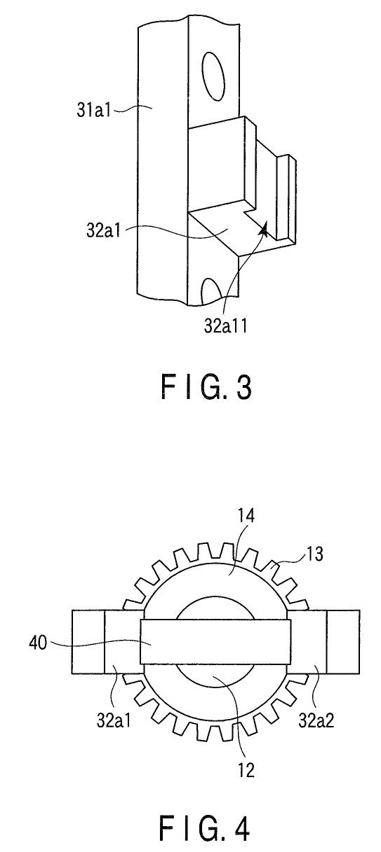

FIG. 3 is a view showing the rotation regulating member 32 in detail. As shown in FIGS. 2B and 3, grooves 32a11 and 32a22 are formed in surfaces of the rotation regulating members 32a1 and 32a2 that face each other.

More specifically, elastic members (not shown) made of rubber or the like are attached to the surfaces (portions which contact the laminated piezoelectric element 40) of the grooves 32a11 and 32a22. This structure hardly transmits vibrations of the laminated piezoelectric element 40 to the frame 31.

Note that the position where the rotation regulating member 32 is arranged is preferably the node position of longitudinal vibrations on the laminated piezoelectric element 40, and near the node position of torsional vibrations. However, when the node position of longitudinal vibrations and that of torsional vibrations on the laminated piezoelectric element 40 do not coincide with each other, the rotation regulating member 32 is preferably arranged near the node position of torsional vibrations.

In other words, the rotation regulating members 32a1 and 32a2 are preferably arranged at positions where they do not inhibit torsional vibrations of the laminated piezoelectric element 40, i.e., positions corresponding to the node position of torsional vibrations of the laminated piezoelectric element 40. By arranging the rotation regulating members 32a1 and 32a2 at these positions, a maximum amplitude of torsional vibrations can be obtained without attenuating the amplitude of torsional vibrations in the laminated piezoelectric element 40 by the rotation regulating members 32a1 and 32a2.

The rotation regulating members 32a1 and 32a2 having this structure can regulate rotation of the laminated piezoelectric element 40 in the same direction as the rotational direction of the gear 13, and tilting of the laminated piezoelectric element 40 (rotation of the laminated piezoelectric element 40 in the direction of width) without inhibiting vibrations of the laminated piezoelectric element 40.

FIG. 4 is a sectional view taken along a line A-A′ shown in FIG. 1. As shown in FIGS. 4 and 2B, the laminated piezoelectric element 40 is inserted from a side on which the press mechanism 20 is attached, between the grooves 32a11 and 32a22 which are formed in the rotation regulating members 32a1 and 32a2 and face each other. The laminated piezoelectric element 40 is fitted in the grooves 32a11 and 32a22. The laminated piezoelectric element 40 is clamped between the grooves 32a11 and 32a22, and positioned while regulating rotation of the laminated piezoelectric element 40 in the same direction as the rotational direction of the gear 13, and rotation (tilting) of the laminated piezoelectric element 40 in the direction of width.

The laminated piezoelectric element 40 is configured as follows.

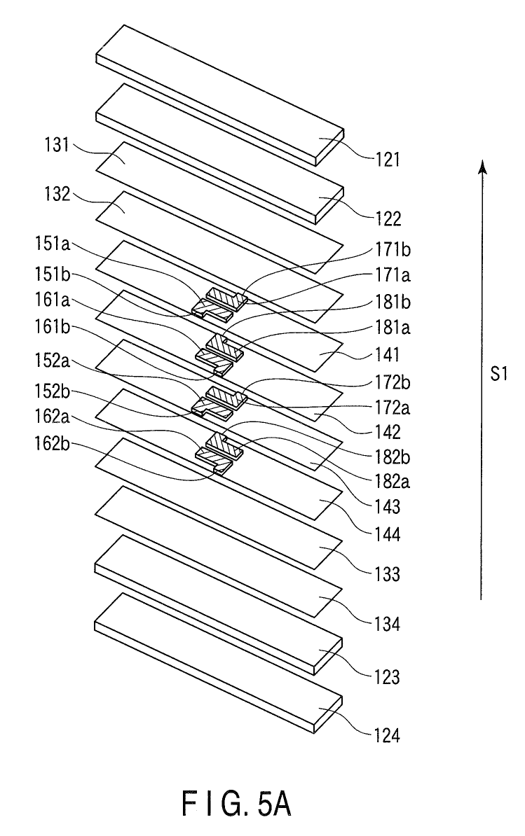

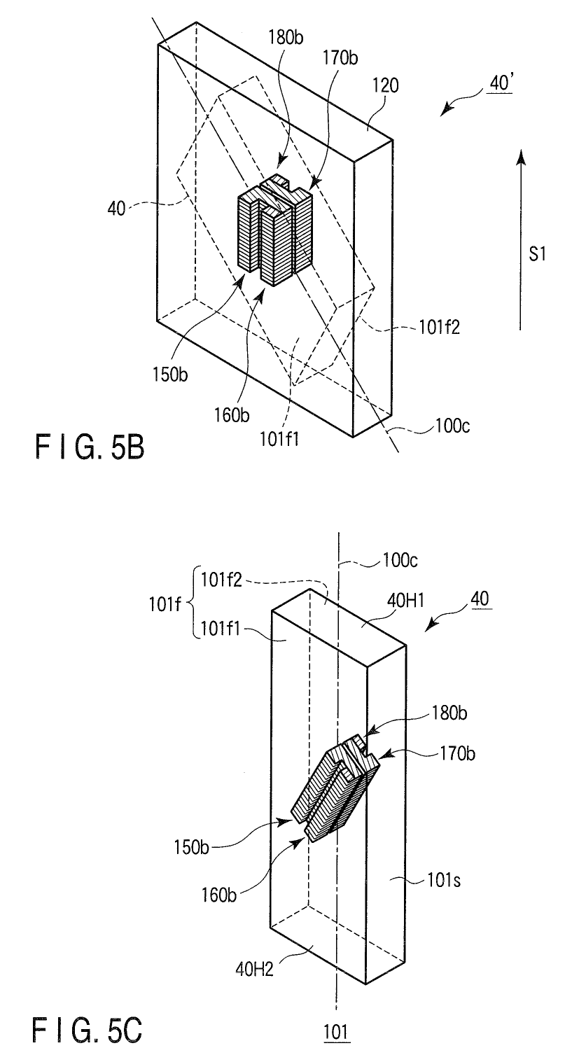

FIG. 5A is an exploded perspective view exemplifying the structure of a piezoelectric sheet laminated body 40′ formed by laminating first piezoelectric sheets 121, 122, 123, and 124, second piezoelectric sheets 131, 132, 133, and 134, and third piezoelectric sheets 141, 142, 143, and 144. FIG. 5B is a perspective view showing a position where the laminated piezoelectric element 40 is cut out from the piezoelectric sheet laminated body 40′.

FIG. 5C is a perspective view showing the structure of the laminated piezoelectric element 40 cut out from the piezoelectric sheet laminated body 40′.

In FIGS. 5B and 5C, electrodes inside the laminated piezoelectric element 40 are visualized, and the respective piezoelectric sheets are illustrated not separately but integrally as the laminated piezoelectric element 40 for descriptive convenience.

The piezoelectric sheet laminated body 40′ is formed by laminating the first piezoelectric sheets 121, 122, 123, and 124, the second piezoelectric sheets 131, 132, 133, and 134, and the third piezoelectric sheets 141, 142, 143, and 144 in the direction of height (direction indicated by an arrow S1 shown in FIG. 5A).

More specifically, the first piezoelectric sheets 121 and 122 are arranged at the top of the piezoelectric sheet laminated body 40′ in the direction of height, and the first piezoelectric sheets 123 and 124 are arranged at the bottom. The second piezoelectric sheets 131, 132, 133, and 134 are interposed between the first piezoelectric sheets 121 and 122 arranged at the top, and the first piezoelectric sheets 123 and 124 arranged at the bottom. The second piezoelectric sheets 131, 132, 133, and 134 are arranged from the upper side in the order named. The third piezoelectric sheets 141, 142, 143, and 144 are interposed between the second piezoelectric sheets 131 and 132 arranged on the upper side, and the second piezoelectric sheets 133 and 134 arranged on the lower side.

In the example shown in FIG. 5A, four first piezoelectric sheets, four second piezoelectric sheets, and four third piezoelectric sheets are used. However, the number of piezoelectric sheets which form the piezoelectric sheet laminated body 40′ is not limited to this example, and can be arbitrarily selected in accordance with the specifications of the laminated piezoelectric element 40.

The first, second, and third piezoelectric sheets are rectangular sheet-like piezoelectric elements. The first, second, and third piezoelectric sheets are made of, for example, hard lead zirconate titanate (PZT) piezoceramics. The third piezoelectric sheet has an internal electrode with an activation area formed by polarization in the direction of thickness, details of which will be described later. The internal electrode can be made of, e.g., a 4-μm thick silver-palladium alloy.

As shown in FIG. 5A, the second piezoelectric sheets 131, 132, 133, and 134 and the third piezoelectric sheets 141, 142, 143, and 144 have almost the same thickness (e.g., 100 μm). As shown in FIG. 5A, the first piezoelectric sheets 121, 122, 123, and 124 are formed thicker than the second piezoelectric sheets 131, 132, 133, and 134 and the third piezoelectric sheets 141, 142, 143, and 144.

As a matter of course, all the first, second, and third piezoelectric sheets may have the same thickness depending on the specifications of the laminated piezoelectric element 40.

The third piezoelectric sheets 141, 142, 143, and 144 are arranged near the node of secondary or tertiary torsional resonant vibrations in the laminated piezoelectric element 40 which is cut out from the piezoelectric sheet laminated body 40′ in the laminated state.

That is, torsional vibrations excited in the laminated piezoelectric element 40 can be set to desired ones (secondary or tertiary torsional vibrations) in accordance with the arrangement positions, in the piezoelectric sheet laminated body 40′ (laminated piezoelectric element 40), of the third piezoelectric sheets 141, 142, 143, and 144 which are piezoelectric sheets having internal electrodes. In other words, the vicinity of a position corresponding to the third piezoelectric sheets 141, 142, 143, and 144 which are piezoelectric sheets having internal electrodes is the node position of torsional vibrations excited in the laminated piezoelectric element 40.

Internal and external electrodes formed on the third piezoelectric sheets 141, 142, 143, and 144 will be described in detail. Two internal electrodes are formed by printing on the upper surface of each of the third piezoelectric sheets 141, 142, 143, and 144.

On the third piezoelectric sheet 141, a first internal electrode 151a of the negative phase and a second internal electrode 171a of the negative phase are arranged at almost the center position in the longitudinal direction to face each other.

The first internal electrode 151a of the negative phase extends along one long side of the third piezoelectric sheet 141 with a rectangular shape, and has an end 151b which is exposed outside at the edge. Similarly, the second internal electrode 171a of the negative phase extends along the other long side of the third piezoelectric sheet 141, and has an end 171b which is exposed outside at the edge.

That is, as shown in FIG. 5A, the ends 151b and 171b are exposed outside at the edges of separate long sides (long sides near them).

On the third piezoelectric sheet 142, a first internal electrode 161a of the positive phase is formed at a position corresponding to the first internal electrode 151a of the negative phase when the third piezoelectric sheet 141 is laminated on the third piezoelectric sheet 142. Further, on the third piezoelectric sheet 142, a second internal electrode 181a of the positive phase is formed at a position corresponding to the second internal electrode 171a of the negative phase when the third piezoelectric sheet 141 is laminated on the third piezoelectric sheet 142.

The first internal electrode 161a of the positive phase extends along one long side of the third piezoelectric sheet 142, and has an end 161b which is exposed outside at the edge. The second internal electrode 181a of the positive phase extends along the other long side of the third piezoelectric sheet 142, and has an end 181b which is exposed outside at the edge.

On the third piezoelectric sheets 141 and 142, activation areas are formed at least at a portion where the first internal electrode 151a of the negative phase and the first internal electrode 161a of the positive phase face each other, and a portion where the second internal electrode 171a of the negative phase and the second internal electrode 181a of the positive phase face each other. In other words, a high voltage is applied between the first internal electrode 151a of the negative phase and the first internal electrode 161a of the positive phase, and between the second internal electrode 171a of the negative phase and the second internal electrode 181a of the positive phase, polarizing the electrodes and piezoelectrically activating them.

The third piezoelectric sheet 143 takes the same electrode layout as that of the third piezoelectric sheet 141. More specifically, a first internal electrode 152a of the negative phase formed on the third piezoelectric sheet 143 corresponds to the first internal electrode 151a of the negative phase formed on the third piezoelectric sheet 141. A second internal electrode 172a of the negative phase formed on the third piezoelectric sheet 143 corresponds to the second internal electrode 171a of the negative phase formed on the third piezoelectric sheet 141. An end 152b formed on the third piezoelectric sheet 143 corresponds to the end 151b formed on the third piezoelectric sheet 141. An end 172b formed on the third piezoelectric sheet 143 corresponds to the end 171b formed on the third piezoelectric sheet 141.

The third piezoelectric sheet 144 takes the same electrode layout as that of the third piezoelectric sheet 142. More specifically, a first internal electrode 162a of the positive phase formed on the third piezoelectric sheet 144 corresponds to the first internal electrode 161a of the positive phase formed on the third piezoelectric sheet 142. A second internal electrode 182a of the positive phase formed on the third piezoelectric sheet 144 corresponds to the second internal electrode 181a of the positive phase formed on the third piezoelectric sheet 142. An end 162b formed on the third piezoelectric sheet 144 corresponds to the end 161b formed on the third piezoelectric sheet 142. An end 182b formed on the third piezoelectric sheet 144 corresponds to the end 181b formed on the third piezoelectric sheet 142.

On the third piezoelectric sheets 143 and 144, activation areas are formed at least at a portion where the first internal electrode 152a of the negative phase and the first internal electrode 162a of the positive phase face each other, and a portion where the second internal electrode 172a of the negative phase and the second internal electrode 182a of the positive phase face each other.

External electrodes are formed by printing with, e.g., silver paste on side surfaces of the piezoelectric sheet laminated body 40′ from which the ends 151b, 152b, 161b, 162b, 171b, 172b, 181b, and 182b of the third piezoelectric sheets 141, 142, 143, and 144 are exposed. FIG. 5B is a perspective view showing a position where the laminated piezoelectric element 40 is cut out from the piezoelectric sheet laminated body 40′. FIG. 5C is a perspective view showing the laminated piezoelectric element 40 cut out from the piezoelectric sheet laminated body 40°.

As shown in FIGS. 5B and 5C, a first external electrode 150b of the negative phase is formed at the ends 151b and 152b. A first external electrode 160b of the positive phase is formed at the ends 161b and 162b. A second external electrode 170b of the negative phase is formed at the ends 171b and 172b. A second external electrode 180b of the positive phase is formed at the ends 181b and 182b.

The first external electrode 150b of the negative phase, the first external electrode 160b of the positive phase, the second external electrode 170b of the negative phase, and the second external electrode 180b of the positive phase are connected to power supplies (not shown) outside the ultrasonic motor 1, respectively. This connection uses an FPC (Flexible Printed Circuit), and one end of the FPC is fixed to each electrode.

More specifically, as shown in FIG. 5B, the first external electrode 150b of the negative phase and the first external electrode 160b of the positive phase are formed on a side surface 101f1 obtained by stacking long sides on one side which form a section (rectangle) perpendicular to a central axis 100c of the laminated piezoelectric element 40. To the contrary, the second external electrode 170b of the negative phase and the second external electrode 180b of the positive phase are formed on a side surface 101f2 obtained by stacking long sides on the other side which form the section (rectangle) perpendicular to the central axis 100c of the laminated piezoelectric element 40.

The laminated piezoelectric element 40 is cut out from the piezoelectric sheet laminated body 40′ so that the lamination direction S1 of the first, second, and third piezoelectric sheets and the central axis 100c form a predetermined angle.

More specifically, the laminated piezoelectric element 40 is preferably cut out from the piezoelectric sheet laminated body 40′ so that the central axis 100c forms, e.g., 45° with respect to the lamination direction S1. When longitudinal vibrations are to be excited strongly, the laminated piezoelectric element 40 is preferably cut out from the piezoelectric sheet laminated body 40′ so that the central axis 100c forms a small angle (e.g., an angle smaller than 45°) with respect to the lamination direction S1. When torsional vibrations are to be excited strongly, the laminated piezoelectric element 40 is preferably cut out from the piezoelectric sheet laminated body 40′ so that the central axis 100c forms an angle larger than, e.g., 45° with respect to the lamination direction S1.

The phases of signals applied to the first external electrode 150b of the negative phase and the first external electrode 160b of the positive phase, and those of signals applied to the second external electrode 170b of the negative phase and the second external electrode 180b of the positive phase preferably shift from each other by about 90°. To obtain a desired motor characteristic, the phase difference may be set to an arbitrary angle other than 90°.

The piezoelectric sheet laminated body 40′ is cut in the above-described way, creating the laminated piezoelectric element 40 so that the thickness effects of the first, second, and third piezoelectric sheets are diagonally arrayed. Then, signals having a phase difference of about 90° as described above are respectively applied to the first external electrode 150b of the negative phase and the first external electrode 160b of the positive phase, and the second external electrode 170b of the negative phase and the second external electrode 180b of the positive phase. As a result, elliptic vibrations are generated on the two end faces of the laminated piezoelectric element 40 in the direction of height (end faces 40H1 and 40H2 shown in FIG. 5C). The elliptic vibrations are then transmitted to the sliding plate 14 via the driving member 41 arranged on the end face 40H1 of the laminated piezoelectric element 40. Along with the rotation of the sliding plate 14, the gear 13 rotates.

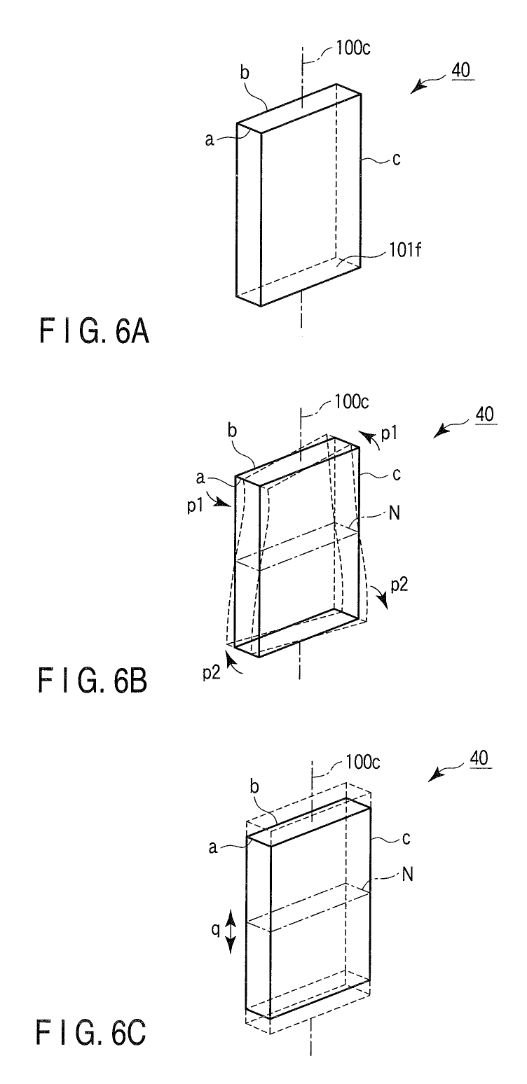

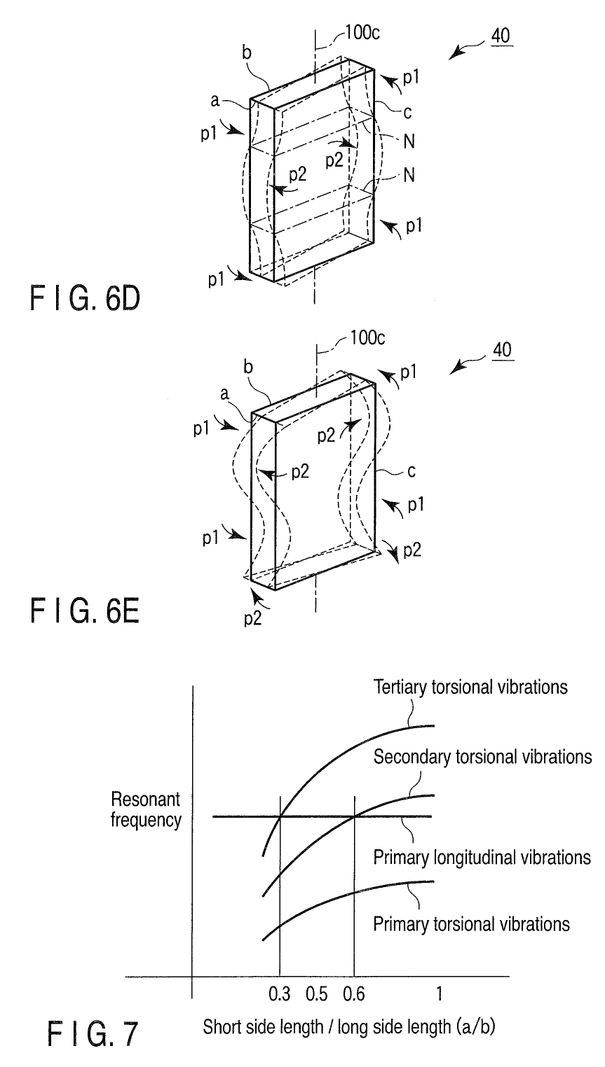

FIGS. 6A, 6B, 6C, 6D, and 6E are perspective views exemplifying the vibration state of the laminated piezoelectric element 40.

More specifically, FIG. 6A is a perspective view showing the laminated piezoelectric element 40 which does not vibrate. FIG. 6B is a perspective view showing the vibration state of the laminated piezoelectric element 40 in the primary torsional vibration mode that is represented by a broken line. FIG. 6C is a perspective view showing the vibration state of the laminated piezoelectric element 40 in the primary longitudinal vibration mode that is represented by a broken line. FIG. 6D is a perspective view showing the vibration state of the laminated piezoelectric element 40 in the secondary torsional vibration mode that is represented by a broken line. FIG. 6E is a perspective view showing the vibration state of the laminated piezoelectric element 40 in the tertiary torsional vibration mode that is represented by a broken line. That is, in FIGS. 6B, 6C, 6D, and 6E, the solid line represents the state (shape) of the laminated piezoelectric element 40 before vibration, and the broken line represents the state (shape) of the laminated piezoelectric element 40 during vibration in each vibration mode.

As shown in FIGS. 6A, 6B, 6C, 6D, and 6E, a is the length of a short side which forms a section perpendicular to the central axis 100c of the laminated piezoelectric element 40 having a rectangular parallelepiped shape, b is the length of the long side, and c is the height along the central axis 100c. Assume that the short side a, long side b, and height c have a relation:

a<b<c

In the following description, the direction of height c is the direction of vibrations in the primary longitudinal vibration mode, and the axial direction of torsion of torsional vibrations.

In the ultrasonic motor according to the first embodiment, the dimensional values of the short side a, long side b, and height c of the laminated piezoelectric element 40 are appropriately set, making the resonant frequency of the primary longitudinal vibration mode and that of the secondary or tertiary torsional vibration mode almost coincide with each other.

In FIGS. 6B, 6C, 6D, and 6E, p1 and p2 are the directions of torsional vibrations, q is the direction of longitudinal vibrations, and N is the node of vibrations.

One node N exists at the center position of the laminated piezoelectric element 40 in the direction of height c in primary torsional vibrations shown in FIG. 6B and primary longitudinal vibrations shown in FIG. 6C. Nodes N exist at two positions in the direction of height c in secondary torsional vibrations shown in FIG. 6D. Further, nodes N exist at three positions in the direction of height c in tertiary torsional vibrations shown in FIG. 6E.

Characteristics shown in FIG. 7 are obtained when the height c of the laminated piezoelectric element 40 is set constant, (short side length a/long side length b) values are plotted along the abscissa, and resonant frequency values in the respective vibration modes are plotted along the ordinate. More specifically, the following characteristics are obtained. That is,
The resonant frequency value in the primary longitudinal vibration mode is almost constant regardless of the (a/b) value.
The resonant frequency values in the primary, secondary, and tertiary torsional vibration modes increase as the (a/b) value increases.
The resonant frequency in the primary torsional vibration mode does not coincide with that in the primary longitudinal vibration mode regardless of the (a/b) value.
The resonant frequency in the secondary torsional vibration mode coincides with that in the primary longitudinal vibration mode around an (a/b) value of 0.6.
The resonant frequency in the tertiary torsional vibration mode coincides with that in the primary longitudinal vibration mode around an (a/b) value of 0.3.

With these characteristics, the (a/b) value is set as follows in the first embodiment. That is,
When the primary longitudinal vibration mode and tertiary torsional vibration mode are used, the short side length a and long side length b of the laminated piezoelectric element 40 are set to have an (a/b) value of 0.25 to 0.35.
When the primary longitudinal vibration mode and secondary torsional vibration mode are used, the short side length a and long side length b of the laminated piezoelectric element 40 are set to have an (a/b) value of 0.55 to 0.65.

In other words, in the ultrasonic motor according to the first embodiment, the ratio of the short side length a to long side length b of the laminated piezoelectric element 40 is set so that the resonant frequency of primary longitudinal resonant vibrations stretching along the central axis 100c of the laminated piezoelectric element 40, and that of secondary or tertiary torsional resonant vibrations using the central axis 100c as the axis of torsion substantially coincide with each other.

Since the resonant frequency can be adjusted in this fashion, special processing and the like for adjustment of the resonant frequency, which are required in the conventional technique, can be omitted.

The laminated piezoelectric element 40 simultaneously excites primary longitudinal resonant vibrations stretching along the central axis 100c (axis of rotation), and secondary or tertiary torsional resonant vibrations using the central axis 100c as the axis of torsion. These vibrations are composited, exciting elliptic vibrations.

In other words, primary longitudinal resonant vibrations, and secondary or tertiary torsional resonant vibrations are excited by activation areas formed by polarization in the direction of thickness of the piezoelectric sheets which form the piezoelectric sheet laminated body 40′. The driving member 41 is bonded and fixed to the upper surface of the laminated piezoelectric element 40 after the laminated piezoelectric element 40 is cut out from the piezoelectric sheet laminated body 40′.

The press mechanism 20 presses, against the rotor mechanism 10 by a proper press force, the laminated piezoelectric element 40 held by the housing 30 via the rotation regulating members 32a1 and 32a2. At this time, the spring 21 positioned by the spring regulating member 22a attached to the stationary plate 22 presses the laminated piezoelectric element 40.

When fixing the stationary plate 22 to the frame 31, for example, the spring 21 is flexed to press the laminated piezoelectric element 40 and apply the press force to the rotor mechanism 10. In this state, the stationary plate 22 is fixed to the frame 31 by screwing, bonding, or the like.

The ultrasonic motor 1 according to the first embodiment utilizes the piezoelectric effects of the laminated piezoelectric element 40 as a driving source. The piezoelectric effects are classified into two types:

(longitudinal effect) a piezoelectric effect when the electric field direction and stress direction are parallel to each other. This piezoelectric effect is also called the thickness effect; and (transversal effect) a piezoelectric effect when the electric field direction and stress direction are perpendicular to each other.

The ultrasonic motor 1 according to the first embodiment assumes the “longitudinal effect”, but can use the “transversal effect”.

That is, the shape, dimensions, and the like of the laminated piezoelectric element 40 may be set so that a displacement in a direction perpendicular to the polarization direction becomes dominant (=“transversal effect” is used), or a displacement in a direction in the polarization direction becomes dominant (=“longitudinal effect” is used), as long as elliptic vibrations can be generated on the two end faces of the laminated piezoelectric element 40 serving as a vibrator.

As described above, the first embodiment can provide an ultrasonic motor which can be assembled easily. More specifically, the ultrasonic motor according to the first embodiment can obtain the following effects:
The resonant frequencies of longitudinal and torsional vibrations excited in the laminated piezoelectric element 40 can be adjusted by appropriately setting the dimensions of the laminated piezoelectric element 40.
The structure of the laminated piezoelectric element 40 can be simplified and formed from a single member. Further, special processing of forming a groove or the like, which is necessary in the conventional technique, can be omitted.
The number of building components can be decreased, the manufacturing process can be simplified, and the cost can be reduced.
In the conventional technique, the motor performance may vary or become unstable owing to the complicated structure of the laminated piezoelectric member and difficult assembly. However, the ultrasonic motor according to the first embodiment can solve variations and instability of the motor performance.

Note that the ultrasonic motor according to the first embodiment adopts tertiary torsional vibrations as torsional vibrations excited in the laminated piezoelectric element 40. Needless to say, secondary torsional vibrations may be employed as torsional vibrations excited in the laminated piezoelectric element 40. In this case, the external electrodes 150b, 160b, 170b, and 180b are arranged near the node position of secondary torsional vibrations. The rotation regulating members 32a1 and 32a2 are also arranged near the node position of secondary torsional vibrations.

### Second Embodiment

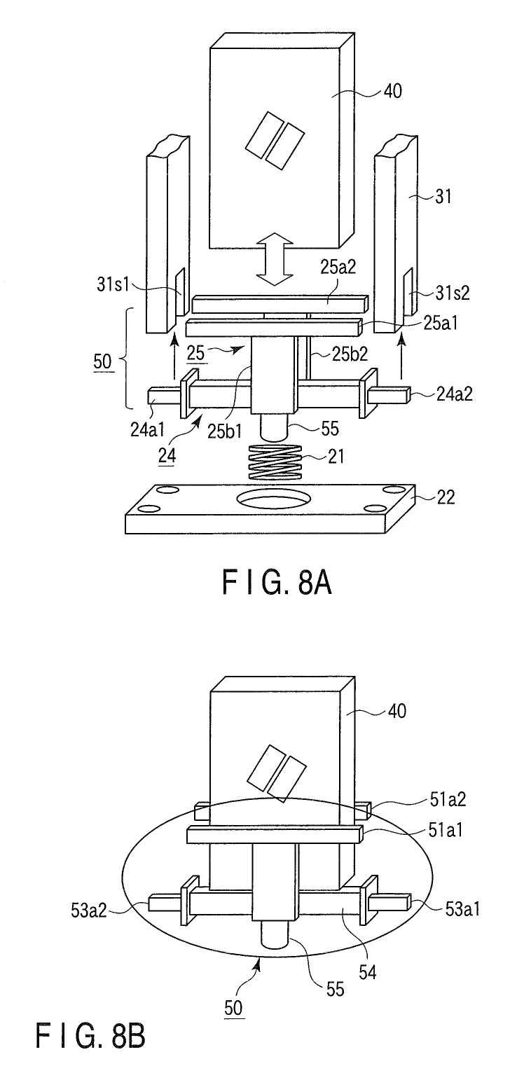

An ultrasonic motor according to the second embodiment of the present invention will be described. To avoid a repetitive description, a difference from the ultrasonic motor according to the first embodiment will be explained. FIG. 8A is an exploded perspective view exemplifying the structure of the ultrasonic motor according to the second embodiment.

In the ultrasonic motor according to the second embodiment, a rotation regulating mechanism 50 replaces the rotation regulating members 32a1 and 32a2 of the ultrasonic motor according to the first embodiment. FIG. 8B is a perspective view exemplifying the structure of the rotation regulating mechanism 50.

Note that grooves 31s1 and 31s2 are formed in frame legs 31a1 and 31a2 of a frame 31 to couple the rotation regulating mechanism 50.

As shown in FIGS. 8A and 8B, the rotation regulating mechanism 50 includes laminated piezoelectric element holders 51a1 and 51a2, a laminated piezoelectric element support portion 54, rotation regulating projections 53a1 and 53a2, and a spring regulating member 55.

The laminated piezoelectric element holders 51a1 and 51a2 are members which clamp a laminated piezoelectric element 40 placed on the laminated piezoelectric element support portion 54 from a surface on which external electrodes 150b and 160b are formed, and a surface on which external electrodes 170b and 180b are formed. The laminated piezoelectric element 40 is clamped between the laminated piezoelectric element holders 51a1 and 51a2 in this manner, and positioned while regulating tilting (rotation of the laminated piezoelectric element 40 in the direction of width). The laminated piezoelectric element holders 51a1 and 51a2 regulate not only the tilting, but also rotation of the laminated piezoelectric element 40 in the same direction as the rotational direction of a gear 13.

The rotation regulating projections 53a1 and 53a2 are projections which are fitted in the grooves 31s1 and 31s2 formed in the frame 31. By fitting the rotation regulating projections 53a1 and 53a2 in the grooves 31s1 and 31s2 formed in the frame 31, respectively, the rotation regulating mechanism 50 is coupled to a housing 30. This coupling regulates rotation of the laminated piezoelectric element 40 (rotation in the same direction as the rotational direction of the gear 13) when the ultrasonic motor 1 is driven.

The piezoelectric element support portion 54 and laminated piezoelectric element 40 are fixed by bonding or the like near the node position of torsional vibrations of the laminated piezoelectric element 40 at the center (central axis) of the laminated piezoelectric element 40 in the direction of width.

The spring regulating member 55 is a projection which positions a spring 21. The spring regulating member 55 is inserted into the spring 21.

As described above, the second embodiment can provide an ultrasonic motor which obtains the same effects as those of the ultrasonic motor according to the first embodiment, and further improves driving stability.

More specifically, separate regulating members regulate tilting of the laminated piezoelectric element 40, and rotation of the laminated piezoelectric element 40 in the same direction as the rotational direction of the gear 13. This can more reliably decrease factors which inhibit torsional vibrations. Since factors which transmit vibrations from the laminated piezoelectric element 40 to the housing 30 also decrease, driving stability is further improved.

### Third Embodiment

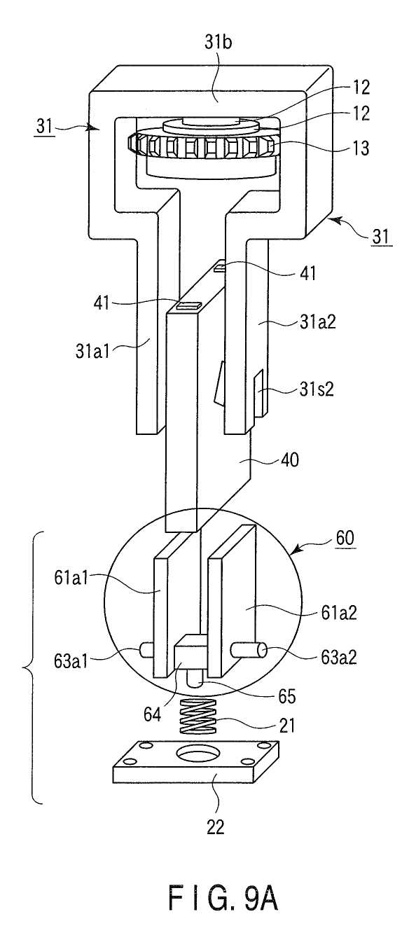

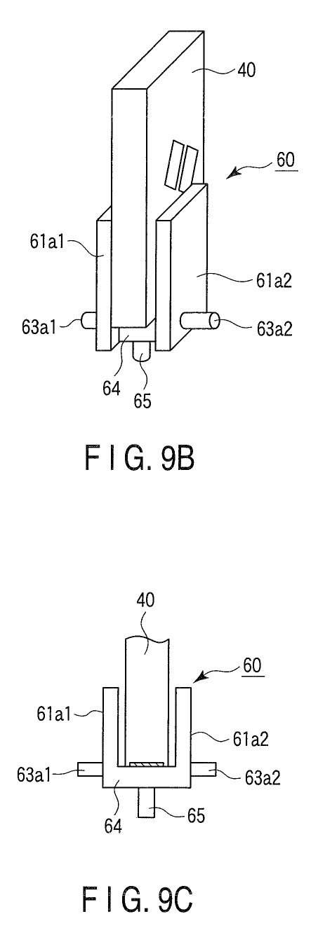

An ultrasonic motor according to the third embodiment of the present invention will be described. To avoid a repetitive description, a difference from the ultrasonic motor according to the first embodiment will be explained. FIG. 9A is an exploded perspective view exemplifying the structure of the ultrasonic motor according to the third embodiment.

In the ultrasonic motor according to the third embodiment, a rotation regulating mechanism 60 replaces the rotation regulating members 32a1 and 32a2 of the ultrasonic motor according to the first embodiment. FIG. 9B is a perspective view exemplifying the structure of the rotation regulating mechanism 60. FIG. 9C is a side view exemplifying the structure of the rotation regulating mechanism 60. Note that grooves 31s1 and 31s2 are formed in frame legs 31a1 and 31a2 of a frame 31 to couple the rotation regulating mechanism 60.

In the ultrasonic motors according to the first and second embodiments, two surfaces of a laminated piezoelectric element 40 on which no external electrode is formed face the frame legs 31a1 and 31a2. To the contrary, in the ultrasonic motor according to the third embodiment, a surface of the laminated piezoelectric element 40 on which external electrodes 150b and 160b are formed, and a surface of it on which external electrodes 170b and 180b are formed face the frame legs 31a1 and 31a2. At portions of the frame legs 31a1 and 31a2 that face the laminated piezoelectric element 40, the interval between the frame legs 31a1 and 31a2 becomes smaller than that in the ultrasonic motors according to the first and second embodiments, as shown in FIG. 9A.

As shown in FIGS. 9A and 9B, the rotation regulating mechanism 60 includes laminated piezoelectric element holders 61a1 and 61a2, a laminated piezoelectric element support portion 64, rotation regulating projections 63a1 and 63a2, and a spring regulating member 65.

The laminated piezoelectric element holders 61a1 and 61a2 are members which clamp the laminated piezoelectric element 40 placed on the laminated piezoelectric element support portion 64 from a surface on which external electrodes 150b and 160b are formed, and a surface on which external electrodes 170b and 180b are formed. The laminated piezoelectric element 40 is clamped between the laminated piezoelectric element holders 61a1 and 61a2 in this fashion, and positioned while regulating tilting of the laminated piezoelectric element 40 (rotation of the laminated piezoelectric element 40 in the direction of width). The laminated piezoelectric element holders 61a1 and 61a2 regulate not only the tilting, but also rotation of the laminated piezoelectric element 40 in the same direction as the rotational direction of a gear 13.

The rotation regulating projections 63a1 and 63a2 are projections which are fitted in the grooves 31s1 and 31s2 formed in the frame 31. By fitting the rotation regulating projections 63a1 and 63a2 in the grooves 31s1 and 31s2 formed in the frame 31, respectively, the rotation regulating mechanism 60 is coupled to a housing 30. This coupling regulates rotation of the laminated piezoelectric element 40 (rotation in the same direction as the rotational direction of the gear 13) when the ultrasonic motor 1 is driven.

The laminated piezoelectric element support portion 64 and laminated piezoelectric element 40 are fixed by bonding or the like near the node of torsional vibrations of the laminated piezoelectric element 40 at the center (central axis) of the laminated piezoelectric element 40 in the direction of width.

The spring regulating member 65 is a projection which positions a spring 21. The spring regulating member 65 is inserted into the spring 21.

As described above, the third embodiment can provide an ultrasonic motor which obtains the same effects as those of the ultrasonic motor according to the first embodiment, and further improves driving stability.

More specifically, separate regulating members regulate tilting of the laminated piezoelectric element 40, and rotation of the laminated piezoelectric element 40 in the same direction as the rotational direction of the gear 13. This can more reliably decrease factors which inhibit torsional vibrations. Since factors which transmit vibrations from the laminated piezoelectric element 40 to the housing 30 also decrease, driving stability is further improved. The ultrasonic motor can be configured by arranging the laminated piezoelectric element 40 bonded and fixed to the laminated piezoelectric element holders 61a1 and 61a2, making assembly more easily.

The present invention has been described based on the first to third embodiments. However, the present invention is not limited to the above-described embodiments, and can be variously modified and applied without departing from the scope of the invention.

Further, the above-described embodiments include inventions on various stages, and various inventions can be extracted by an appropriate combination of building components disclosed. For example, even if several building components are omitted from all those described in the embodiments, an arrangement from which the building components are omitted can also be extracted as an invention as long as the problems described in Description of the Related Art can be solved and effects described in BRIEF SUMMARY OF THE INVENTION can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic motor comprising:
a vibrator whose section perpendicular to a central axis has a rectangular shape, in which a ratio of a short side to a long side that form the rectangular shape is set to a predetermined value, and which generates an elliptic vibration by simultaneously exciting a longitudinal vibration stretching along the central axis, and a torsional vibration using the central axis as an axis of torsion;
a rotor mechanism which abuts against an elliptic vibration generating surface of the vibrator and is driven by the elliptic vibration to rotate using the central axis as an axis of rotation;
a press mechanism which presses the vibrator against the rotor mechanism to bring the elliptic vibration generating surface of the vibrator into press contact with the rotor mechanism;
a frame which supports the rotor mechanism and the vibrator; and
a regulating unit which regulates rotation of the vibrator by clamping the vibrator together with the frame.

2. The motor according to claim 1, wherein the ratio of the short side to the long side that form the rectangular shape has a value at which a resonant frequency of the longitudinal vibration and a resonant frequency of the torsional vibration substantially coincide with each other.

3. The motor according to claim 2, wherein
the longitudinal vibration is a primary longitudinal vibration, and
the torsional vibration is one of a secondary torsional vibration and a tertiary torsional vibration.

4. The motor according to claim 2, wherein
the regulating unit is a projection arranged near a node position of the torsional vibration of the vibrator, and
the projection and the vibrator are engaged with each other to regulate rotation in the same direction as a rotational direction of the rotor mechanism, and rotation of the vibrator in a direction of width.

5. The motor according to claim 4, wherein the projection of the regulating unit has an elastic member on an abutment surface with the vibrator.

6. The motor according to claim 2, wherein
the vibrator includes a driving member arranged on the elliptic vibration generating surface, and
the rotor mechanism includes
a sliding plate which is slid by the driving member, and
a gear which is driven to rotate along with rotation of the sliding plate.

7. The motor according to claim 2, wherein the press mechanism includes
a stationary plate which is fixed to the frame,
a spring which is arranged on the stationary plate and presses the vibrator against the rotor mechanism, and
a projection which is arranged on the stationary plate, inserted into the spring, and positions the spring.

8. The motor according to claim 2, wherein a resonant frequency of the rotor mechanism is different in value from a driving frequency of the vibrator.

9. The motor according to claim 2, wherein a resonant frequency of the frame is different in value from a driving frequency of the vibrator.

10. The motor according to claim 2, wherein the regulating unit includes
a support portion on which the vibrator is placed,
a holder which holds the vibrator by clamping two surfaces that are perpendicular to the elliptic vibration generating surface of the vibrator and parallel to each other, and
a regulating projection configured to fix the support portion and the frame.
